(19) United States
(12) Patent Application Publication
(10) Pub. No.: US 2025/0202078 A1
(43) Pub. Date: Jun. 19, 2025

(54) TERMINAL CONNECTIONS FOR EXTERNAL TABS OF BATTERY CELLS

(71) Applicant: GM GLOBAL TECHNOLOGY OPERATIONS LLC, Detroit, MI (US)

(72) Inventors: Masoud MOHAMMADPOUR, Novi, MI (US); Junjie Ma, Novi, MI (US); Teresa Jean Rinker, Royal Oak, MI (US); Andrew Hromadka, Ann Arbor, MI (US); Hui-ping Wang, Troy, MI (US)

(21) Appl. No.: 18/541,652

(22) Filed: Dec. 15, 2023

(51) Int. Cl. H01M 50/553; H01M 50/233; H01M 50/516; H01M 50/54; H01M 50/55; H01M 50/566

(52) U.S. Cl. CPC H01M 50/553; H01M 50/233; H01M 50/516; H01M 50/54; H01M 50/55; H01M 50/566

(57) ABSTRACT

A battery cell includes a stack including C cathode electrodes each including a cathode current collector, a cathode active layer, and an external tab, A anode electrodes each including an anode current collector, an anode active layer, and an external tab, S separators, and an internal terminal including a slot. The external tabs of one of the C cathode electrodes and the A anode electrodes extend through the slot and are welded in the slot, the slot is open-ended and defines a first leg and a second leg on opposite sides of the slot, and each of the first leg and the second leg is tapered where a first width of the slot at an open end of the slot is greater than a second width of the slot at a closed end of the slot.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to laser welded internal terminals for external tabs of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes a stack including C cathode electrodes each including a cathode current collector, a cathode active layer arranged on the cathode current collector, and an external tab extending from the cathode current collector, A anode electrodes each including an anode current collector, an anode active layer arranged on the anode current collector, and an external tab extending from the anode current collector, S separators, where C, A and S are integers greater than one, and an internal terminal including a slot. The external tabs of one of the C cathode electrodes and the A anode electrodes extend through the slot and are welded in the slot, the slot is open-ended and defines a first leg and a second leg on opposite sides of the slot, and each of the first leg and the second leg is tapered where a first width of the slot at an open end of the slot is greater than a second width of the slot at a closed end of the slot.

In some examples, the closed end of the slot defines at least a partially circular opening configured to facilitate clamping of the first leg and the second leg prior during for welding of the external tabs of the one of the C cathode electrodes and the A anode electrodes extending through the slot.

In some examples, the internal terminal is “L”-shaped and includes a first portion and a second portion extending transversely relative to the first portion, a plane of the second portion of the internal terminal is perpendicular to an extension direction of the external tabs of the one of the C cathode electrodes and the A anode electrodes through the slot, the slot is defined on the second portion of the internal terminal.

In some examples, a taper of each of the first leg and the second leg extends from the closed end of the slot to the open end of the slot.

In some examples, each of the first leg and the second leg includes a taper portion and a straight portion, the second width of the slot is constant along the straight portion of the first leg and the second leg, and the taper portion includes a chamfer at the open end of the slot.

In some examples, each of the first leg and the second leg includes a taper portion and a straight portion, the second width of the slot is constant along the straight portion of the first leg and the second leg, and the taper portion includes a round curve at the open end of the slot.

In some examples, a weld of the slot to the external tabs of the one of the C cathode electrodes and the A anode electrodes extending through the slot is a laser oscillation weld.

A battery cell includes a stack including C cathode electrodes each including a cathode current collector, a cathode active layer arranged on the cathode current collector, and an external tab extending from the cathode current collector, A anode electrodes each including an anode current collector, an anode active layer arranged on the anode current collector, and an external tab extending from the anode current collector, and S separators, where C, A and S are integers greater than one, an internal terminal top plate, an internal terminal first leg, and an internal terminal second leg. The external tabs of one of the C cathode electrodes and the A anode electrodes extend between the internal terminal first leg and the internal terminal second leg, and are welded to the internal terminal first leg and the internal terminal second leg, the internal terminal first leg is welded to the internal terminal top plate, and the internal terminal second leg is welded to the internal terminal top plate.

In some examples, the internal terminal top plate is “L”-shaped and includes a first portion and a second portion extending transversely relative to the first portion, and the internal terminal first leg and the internal terminal second leg are welded to opposite sides of the second portion of the internal terminal top plate.

In some examples, the internal terminal top plate includes a protrusion extending along a center of a surface of the internal terminal top plate, and the internal terminal first leg and the internal terminal second leg are welded to opposite sides of the protrusion of the internal terminal top plate.

In some examples, an angle between a plane of the internal terminal top plate and a longitudinal direction of the internal terminal first leg and the internal terminal second leg is ninety degrees.

In some examples, each of the internal terminal top plate, the internal terminal first leg, and the internal terminal second leg, are rectangular.

In some examples, each of the internal terminal first leg and the internal terminal second leg includes a curved portion and a straight portion, and the curved portion of each of the internal terminal first leg and the internal terminal second leg is welded to the internal terminal top plate.

In some examples, a first width between the straight portion of each of the internal terminal first leg and the internal terminal second leg is less than a width between the curved portion of each of the internal terminal first leg and the internal terminal second leg where each curved portion is welded to the internal terminal top plate.

In some examples, the internal terminal second leg is “L”-shaped and includes a first portion and a second portion extending transversely relative to the first portion, and the first portion of the internal terminal second leg is welded to the internal terminal top plate.

In some examples, a thickness of each of the internal terminal first leg and the internal terminal second leg is less than a thickness of the internal terminal top plate.

In some examples, a thickness of each of the internal terminal first leg and the internal terminal second leg is greater than or equal to a thickness of the internal terminal top plate.

A battery cell includes a stack including C cathode electrodes each including a cathode current collector, a cathode active layer arranged on the cathode current collector, and an external tab extending from the cathode current collector, A anode electrodes each including an anode current collector, an anode active layer arranged on the anode current collector, and an external tab extending from the anode current collector, and S separators, where C, A and S are integers greater than one, an internal terminal, and a side plate. The internal terminal is “L”-shaped and includes a first portion and a second portion extending transversely relative to the first portion, the external tabs of one of the C cathode electrodes and the A anode electrodes extend between the second portion of the internal terminal and the side plate, and are welded to the second portion of the internal terminal and the side plate, and a plane of the second portion of the internal terminal and a plane of the side plate are parallel to an extension direction of the external tabs of the one of the C cathode electrodes and the A anode electrodes extending between the second portion of the internal terminal and the side plate.

In some examples, the side plate is welded to only the second portion of the internal terminal and the external tabs of the one of the C cathode electrodes and the A anode electrodes extending between the second portion of the internal terminal and the side plate, without any welds between the side plate and the first portion of the internal terminal.

In some examples, a thickness of the side plate is less than a thickness of the second portion of the internal terminal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell;

FIG. 2 is a perspective view of an example of a prismatic battery cell including laser welded internal terminals that are in contact with external terminals according to the present disclosure;

FIG. 3 is a perspective view of an example of a prismatic battery cell including electrodes with external tabs that are to be laser welded to the internal terminals;

FIG. 4 is a perspective view illustrating joining of the external tabs of electrodes to an inner surface of an internal terminal;

FIGS. 5A to 5D, are cross sectional illustrations of examples of connection of external tabs to terminals, where the cross section plane A-A is illustrated in FIG. 3;

FIGS. 5E and 5F are examples of weld cross sections where external tabs are welded to pre-welded foils and not including pre-welded foils, respectively;

FIGS. 6A to 6C are perspective views illustrating examples of an internal terminal including an open ended slot defined by tapered legs, and external tabs of electrodes laser welded within the slot, according to the present disclosure;

FIGS. 7A to 7C are front views illustrating slots of internal terminals having different taper profiles;

FIGS. 8A and 8B are perspective views illustrating examples of an internal terminal including a top plate and two side legs, with external tabs of electrodes laser welded between the two side legs;

FIG. 8C is a side view of the internal terminal of FIGS. 8A and 8B, illustrating welding of the two side legs to the top plate, and welding of the external tabs of the electrodes between the two side legs;

FIGS. 9A and 9B are perspective views illustrating examples of an internal terminal including a top plate having a protrusion, and external tabs of electrodes welded between two side legs of the internal terminal;

FIG. 10 is side view of an internal terminal having side legs with curved portions;

FIG. 11 is a side view of an internal terminal having a side leg with perpendicular top and side portions; and

FIGS. 12A and 12B are side views of an external tabs of electrodes welded between an internal terminal and a side plate.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Some example embodiments described herein include designs for connection of external tabs of a battery cell (e.g., battery electrode foils) to a terminal of the battery cell, by inserting the external tabs through a slot in the terminal, and welding the external tabs within the slot (such as via laser oscillation welding). In some examples, the battery cell may be a prismatic battery cell for a vehicle.

An open-ended slot may be defined by legs of the terminal, where the legs include tapered portions to facilitate insertion of the external tabs into the slot. In some examples, legs may be separate from a top plate of the terminal in order to place the legs around sides of the external tabs, prior to welding the tabs to the legs and welding the legs to the terminal top plate (e.g., via a butt joint configuration). In other examples, a side plate may be used for welding, where the side plate is not joined to a top portion of the terminal.

In some examples, the terminal legs on opposite sides of the external tabs may facilitate good contact between foils of the external tabs, and may allow for clamping of the external tabs between the terminal legs. This may contribute to a reduction of weld porosity, and a reduction or prevention of foils-to-terminal weld failure.

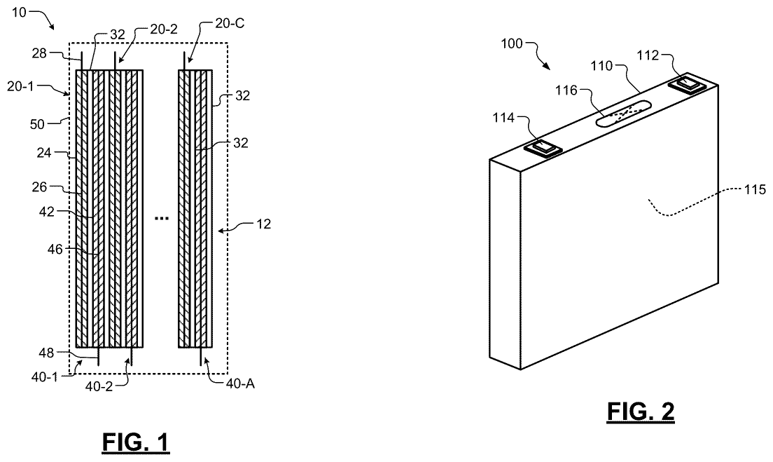

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26.

During charging/discharging, the A anode electrodes 40 and the C cathode electrodes 20 exchange lithium ions. The A anode electrodes 40-1, 40-2, . . . , and 40-A include anode active material layers 42 arranged on one or both sides of the anode current collectors 46. In some examples, the cathode active material layers 24 and the anode active material layers 42 comprise coatings including one or more active materials, one or more conductive additives, and/or one or more binder materials that are applied to the current collectors.

In some examples, the cathode current collector 26 comprises metal foil, metal mesh, perforated metal, 3 dimensional (3D) metal foam, and/or expanded metal. In some examples, the anode current collector 46 comprises roughened metal foil (e.g., copper foil). In some examples, the current collectors are made of one or more materials selected from a group consisting of copper, stainless steel, brass, bronze, zinc, aluminum, and/or alloys thereof.

External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells as will be described further below.

Referring now to FIG. 2, a prismatic battery cell 100 includes an enclosure 110. In some examples, the enclosure 110 has a rectangular cross-section. The prismatic battery cell 100 includes external terminals 112 and 114 and a vent cap 116.

A stack 115 of the C cathode electrodes 20, the A anode electrodes 40, and the S separators 32 is arranged in the enclosure 110. As will be described further below, the anode current collectors 46 and/or the cathode current collectors 26 include external tabs that are laser welded to internal terminals contacting the external terminals 112 and 114 of the battery cell 10.

Referring now to FIG. 3, a prismatic battery cell 200 includes an enclosure 210 and internal terminals 224 and 226 arranged at opposite ends of the enclosure 210. A stack 240 of the C cathode electrodes, the A anode electrodes, and the S separators is arranged in the enclosure 210.

The anode current collectors and/or the cathode current collectors include external tabs 244 and 246 that extend therefrom, respectively. The external tabs 244 and 246 are laser welded to inner surfaces of the internal terminals 224 and 226, respectively.

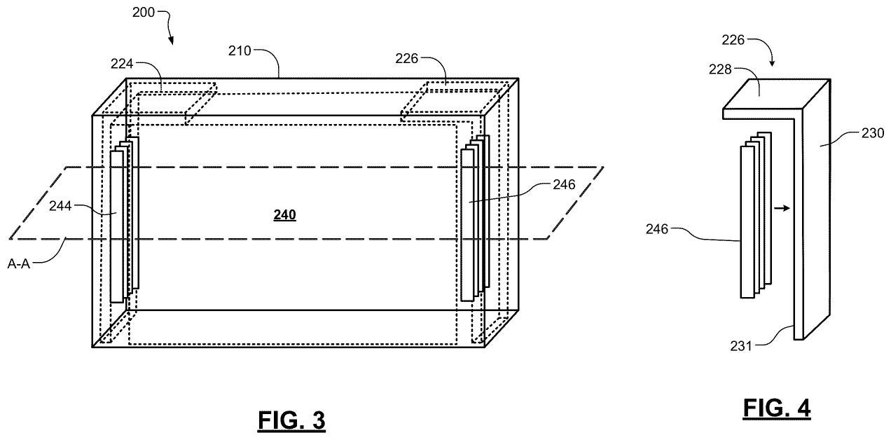

In FIG. 4, the internal terminal 226 includes a first portion 228 and a second portion 230 extending from the first portion 228. In some examples, the first portion 228 is “L”-shaped and forms an angle in a range from 80° to 100° (e.g., 90°) relative to the second portion 230.

In some examples, the external tabs 246 are laser welded to an inner surface 231 of the internal terminal 226, respectively. Laser welding the external tabs 244 and 246 using this approach is difficult. The internal terminal 226 contacts one of the external terminals 112 and 114 of the battery cell 10 to provide an external connection to the anode or cathode electrodes.

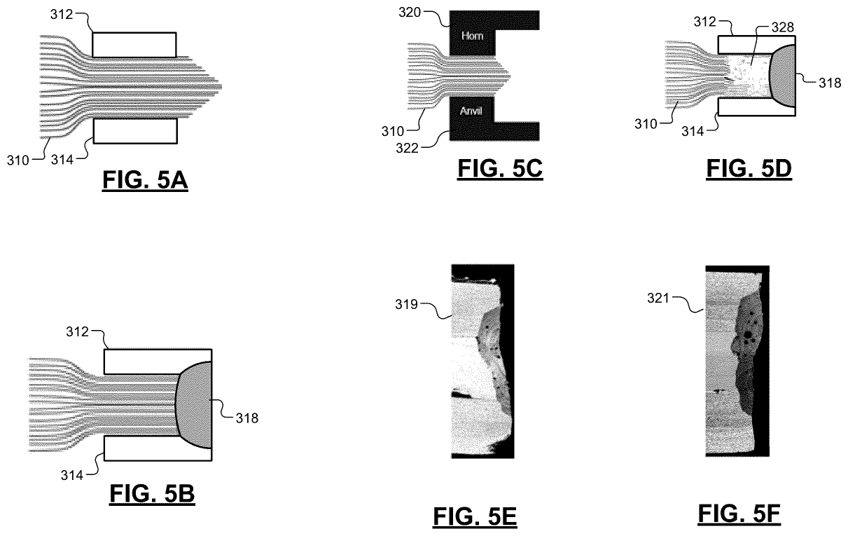

Referring now to FIGS. 5A to 5F, examples of connection of external tabs to terminals are shown. In FIGS. 5A and 5B, a plurality of external tabs 310 extending from the anode electrodes and cathode electrodes are arranged between terminals 312 and 314 and welded (e.g., laser welded) as shown at 318.

In FIGS. 5C and 5D, ultrasonic welding of the plurality of external tabs 310 can be performed prior to welding as shown at 328. For example, the plurality of external tabs 310 may be placed between a horn 320 and an anvil 322, in order to perform ultrasonic welding of the plurality of external tabs 310, as shown in FIG. 5C. The ultrasonic welded group of tabs may then be placed between terminals 312 and 314 for welding (e.g., laser welding) as shown at 318 in FIG. 5D.

In FIGS. 5E and 5F, enlarged illustrations of example welds between external tabs of foils and internal terminals are shown. FIG. 5E illustrates an example weld between external tabs of foils and internal terminals where the group of foils are pre-welded via ultrasonic welding as illustrated in FIG. 5C. FIG. 5F illustrates an example weld where the group of foils are not pre-welded prior to welding to internal terminals.

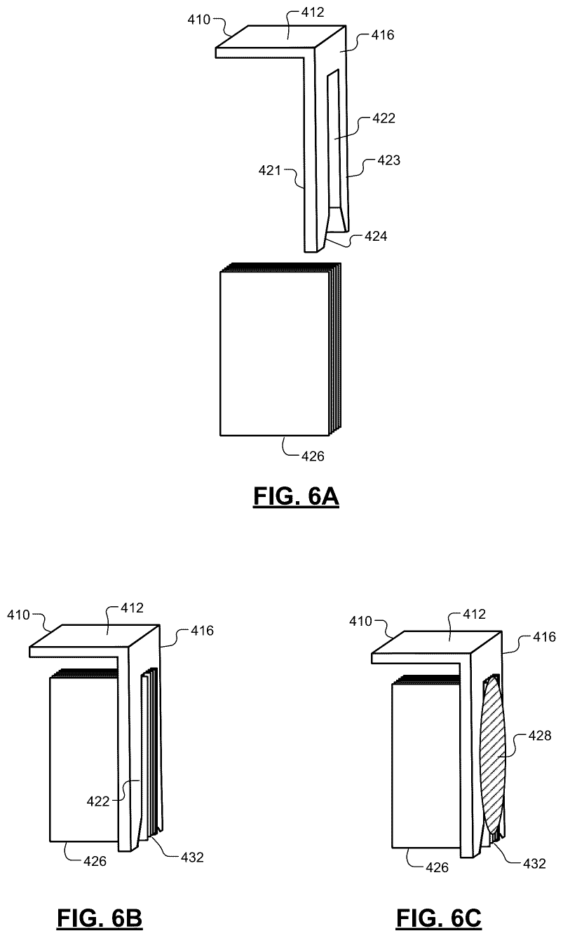

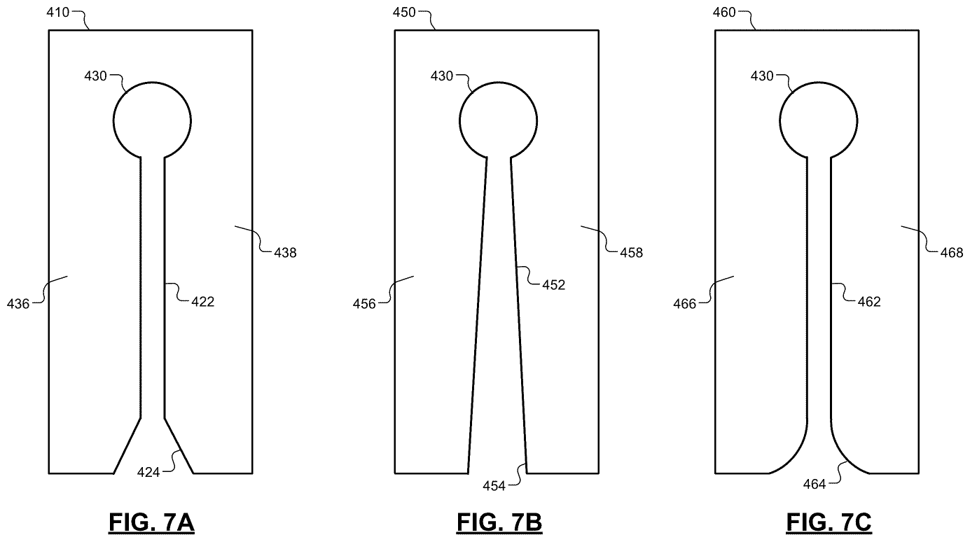

Referring now to FIGS. 6A to 6C, a terminal 410 includes a first portion 412 and a second portion 416 extending at an angle (e.g., approximately perpendicular) relative to the first portion 412. In some examples, the first portion 412 and the second portion 416 have a rectangular shape, although other shapes can be used.

The second portion 416 of the terminal 410 includes a slot 422 that extends in a longitudinal direction on the second portion 416. In some examples, the slot 422 extends to an edge of the second portion 416 distal from the first portion 412. For example, the slot 422 may be open-ended (e.g., the slot 422 may have a closed end adjacent the first portion 412 of the terminal 410 and an open end at a side of the second portion 416 opposite the first portion 412).

The slot 422 includes two legs 421 and 423. Each leg has a taper portion 424. The legs 421 and 423 may define a width of the slot 422, where a width of the slot 422 at the open end is greater than a width at the closed end. Each leg 421 and 423 may include any suitable taper profile. Some example taper profiles for the legs 421 and 423 are shown in FIGS. 7A-7C.

The taper portion 424 may be configured to facilitate insertion of a plurality of external tabs 426 into the slot 422. In FIG. 6B, a plurality of external tabs 426 is partially inserted into the slot 422. For example, the slot 422 may be positioned over the plurality of external tabs 426 as shown in FIG. 6A, and then terminal 410 may be lowered onto the plurality of external tabs 426 (and/or the plurality of external tabs 426 may be raised into the slot 422).

Ends 432 of the plurality of external tabs 426 extend outwardly. The ends 432 of the plurality of external tabs 426 may be aligned with a surface of the second portion 416 of the terminal 410, or may extend beyond the surface of the second portion 416 of the terminal 410. The taper portion 424 may allow for some tolerance to receive the ends 432 when the plurality of external tabs 426 first enter the slot 422, while the taper portion 424 provides a narrower width higher up the slot 422 to press the plurality of external tabs 426 more closely together.

In FIG. 6C, the ends 432 of the plurality of external tabs 426 are connected to the legs 421 and 423 of the terminal 410 via a laser weld 428. For example, once the ends 432 of the plurality of external tabs 426 are received in the slot 422, a laser welding operation may be performed on the ends 432 and the terminal 410 to weld the plurality of external tabs 426 to the terminal 410. A clamping force may optionally be applied to the sides of the legs 421 and 423 prior to welding, such as via one or more clamps pressing the legs 421 and 423 toward one another.

The slot 422 may facilitate increased stability to the welding between the terminal 410 and the ends 432 of the plurality of external tabs 426, such as by pressing the ends 432 together via lateral force, the taper portion 424 facilitating a tight fit of the ends 432 between the legs 421 and 423 of the terminal, etc.

FIGS. 7A to 7C are front views illustrating slots of internal terminals having different taper profiles. FIG. 7A illustrates a terminal 410 including a partial circular opening 430 at the closed end of the slot 422. The partial circular opening 430 may facilitate clamping of the legs 436 and 438, by allowing the legs 436 and 438 to move towards one another when a lateral clamping force is applied at each side of the legs 436 and 438 (e.g., when ends of external tabs are located in the slot 422 during a welding process).

As shown in FIG. 7A, the taper portion 424 includes a chamfered corner of each leg 436 and 438. The chamfered corner extends less than halfway up the slot 422, which allows a majority of the slot 422 to have a narrower width in order to apply greater pressure on ends of external tabs received in the slot 422.

FIG. 7B illustrates an example terminal 450 where the taper portion 454 of the slot 452 extends all the way up each leg 456 and 458. In this example, the taper portion 454 extends from the open end of the slot 452 to the closed end of the slot 452 where the partial circular opening 430. This arrangement may provide for a more gradual narrowing of the slot 452, which may reduce abrupt changes in pressure on the ends of the external tabs, reducing a likelihood of damaging the ends of the external tabs as they are inserted into the slot 452.

FIG. 7C illustrates an example terminal 460 where the taper portion 464 of the slot 462 is a rounded curve at the end of each leg 466 and 468. The rounded curve may facilitate smoother entry of the ends of the external tabs into the slot 462, while leaving a majority of the slot 462 having a narrower width.

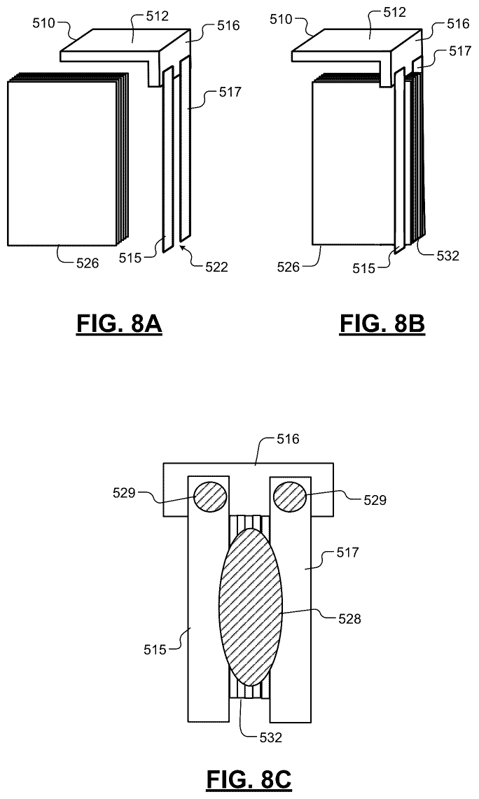

Referring now to FIGS. 8A to 8C, a terminal 510 includes a first portion 512 and a second portion 516 extending at an angle (e.g., approximately perpendicular) relative to the first portion 512. In some examples, the first portion 512 and the second portion 516 have a rectangular shape, although other shapes can be used.

A first leg 515 and a second leg 517 are separate from the terminal 510. In some examples, the first portion 512 and the second portion 516 may be considered as a terminal top plate, and the first leg 515 and the second leg 517 may be considered as a terminal legs. Longitudinal directions of the first leg 515 and the second leg 517 may be substantially parallel to one another, and substantially parallel to a surface of the second portion 516. The first leg 515 and second leg 517 may extend perpendicular to a surface of the first portion 512.

The first leg 515 and the second leg 517 may have a generally rectangular shape, although other shapes may be used in other embodiments. The first leg 515 and the second leg 517 may have a same thickness as the terminal 510, or a greater or lesser thickness.

The first leg 515 and the second leg 517 may be arranged to define a slot 522 between the first leg 515 and the second leg 517. The slot 522 is open-ended at and end of the slot opposite the terminal 510. The slot 522 may be configured to facilitate insertion of a plurality of external tabs 526 into the slot 522. In FIG. 8B, a plurality of external tabs 526 is partially inserted into the slot 522. For example, the first leg 515 and the second leg 517 may be placed on opposite sides of ends 532 of the plurality of external tabs 526, and brought towards one another to press the ends 532 together within a slot 522 between the first leg 515 and the second leg 517.

As shown in FIG. 8C, a laser weld 528 is used to join the ends 532 of the plurality of external tabs 526 to the first leg 515 and the second leg 517. In addition, laser welds 529 are used to join the first leg 515 to the second portion 516 of the terminal 510, and to join the second leg 517 to the second portion 516 of the terminal 510. In some examples, the laser welds 529 may be performed on a same side of the terminal 510 as the laser weld 528, without moving the terminal 510.

In this example, the terminal 510, the first leg 515 and the second leg 517 are initially separate from one another, and are placed around the ends 532 of the plurality of external tabs 526. The first leg 515 and the second leg 517 are pressed together against the ends 532 (such as via clamps), and welded with the ends 532. The first leg 515 and the second leg 517 are also welded to the terminal 510, to complete joining of the plurality of external tabs 526 to the terminal 510. This approach may reduce the chances of damaging the plurality of external tabs 526.

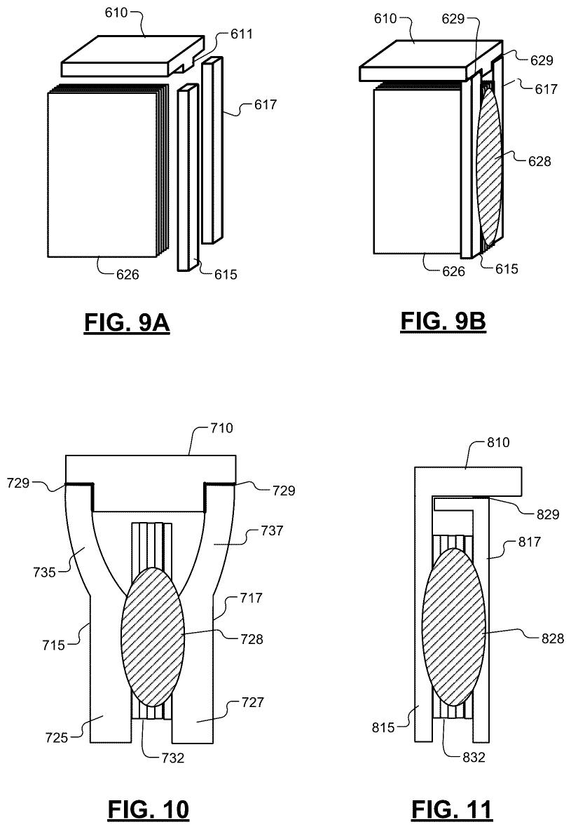

Referring now to FIGS. 9A and 9B, a terminal 610 includes a protrusion 611 extending from a surface of the terminal 610. The protrusion 611 may extend from a center of the surface of the terminal 610, may extend longitudinally down a middle of the terminal 610, may face downwards towards a plurality of external tabs 626, etc. In some examples, the terminal 610 and the protrusion 611 have a rectangular shape, although other shapes can be used.

A first leg 615 and a second leg 617 are separate from the terminal 610. In some examples, the terminal 610 including the protrusion 611 may be considered as a terminal top plate, and the first leg 615 and the second leg 617 may be considered as a terminal legs. Longitudinal directions of the first leg 615 and the second leg 617 may be substantially parallel to one another, and substantially perpendicular to a longitudinal direction of the protrusion 611. The first leg 615 and the second leg 617 may have a generally rectangular shape, although other shapes may be used in other embodiments.

The first leg 615 and the second leg 617 may be arranged to define a slot 622 between the first leg 615 and the second leg 617. The slot 622 is open-ended at and end of the slot opposite the terminal 610. The slot 622 may be configured to facilitate insertion of a plurality of external tabs 626 into the slot 622. In FIG. 8B, a plurality of external tabs 526 is partially inserted into the slot 622. For example, the first leg 615 and the second leg 617 may be placed on opposite sides of ends 632 of the plurality of external tabs 626, and brought towards one another to press the ends 632 together within a slot 622 between the first leg 615 and the second leg 617.

As shown in FIG. 9B, a laser weld 628 is used to join the ends of the plurality of external tabs 626 to the first leg 615 and the second leg 617. In addition, laser welds 629 are used to join the first leg 615 to the protrusion 611 of the terminal 610, and to join the second leg 617 to the protrusion 611.

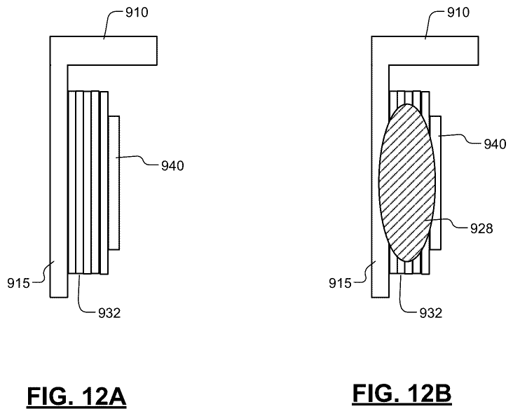

FIG. 10 is side view of a terminal 710 having side legs with curved portions. The first leg 715 includes a straight portion 725 and a curved portion 735 extending from the straight portion 725. The second leg 717 includes a straight portion 727 and a curved portion 737 extending from the straight portion 727.

The ends 732 of the plurality of external tabs are welded to the first leg 715 and the second leg 717 via a laser weld 728. For example, the ends 732 may be welded between the straight portions 725 and 727. The curved portions 735 and 737 may joined to the terminal 710 via laser welds 729.

FIG. 11 is a side view of a terminal 810 having a side leg with perpendicular top and side portions. As shown in FIG. 11, the terminal 810 has a generally perpendicular shape, with a first leg 815 extending down from a top portion of the terminal 810.

A second leg 817 has a generally perpendicular shape, which may be opposite to the terminal 810. For example, a top surface of an upper portion of the second leg 817 may be connected to a bottom surface of the top portion of the terminal 810 via a laser weld 829. The ends 832 of a plurality of external tabs may be connected between the first leg 815 and the second leg 817 via a laser weld 828. In some examples, a plane of the first leg 815 and a plane of the second leg 817 are parallel to an extension direction of the ends 832 of the plurality of external tabs.

Referring now to FIGS. 12A and 12B, a terminal 910 includes a first leg 915. The first leg 915 may be generally perpendicular to the top portion of the terminal 910. A side plate 940 is located opposite the first leg 915, with ends 932 of a plurality of external tabs between the side plate 940 and the first leg 915.

The ends 932 may be connected between the side plate 940 and the first leg 915 via a laser weld 928, as shown in FIG. 12B. In some examples, the side plate 940 may be welded only to the ends 932 and the first leg 915, without any welding between the side plate 940 and a top portion of the terminal 910. Use of the side plate 940 may allow for clamping of the foil stack to facilitate good contact among the plurality of external tabs, which may contribute to a reduction of weld porosity, and a reduction or prevention of foil-to-weld bead failure.

The side plate 940 may have a thickness which is the same as a thickness of the terminal 910, or the side plate 940 may have a greater or lesser thickness. A smaller thickness of the side plate 940 may allow for weight reduction. In some examples, a plane of the first leg 915 and a plane of the side plate 940 may be parallel to an extension direction of the ends 932 of the plurality of external tabs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery cell, comprising:
a stack including:
C cathode electrodes each including a cathode current collector, a cathode active layer arranged on the cathode current collector, and an external tab extending from the cathode current collector;
A anode electrodes each including an anode current collector, an anode active layer arranged on the anode current collector, and an external tab extending from the anode current collector; and
S separators, where C, A and S are integers greater than one; and
an internal terminal including a slot, wherein,
the external tabs of one of the C cathode electrodes and the A anode electrodes extend through the slot and are welded in the slot,
the slot is open-ended and defines a first leg and a second leg on opposite sides of the slot, and
each of the first leg and the second leg is tapered where a first width of the slot at an open end of the slot is greater than a second width of the slot at a closed end of the slot.

2. The battery cell of claim 1, wherein the closed end of the slot defines at least a partially circular opening configured to facilitate clamping of the first leg and the second leg prior during for welding of the external tabs of the one of the C cathode electrodes and the A anode electrodes extending through the slot.

3. The battery cell of claim 1, wherein:
the internal terminal is “L”-shaped and includes a first portion and a second portion extending transversely relative to the first portion;
a plane of the second portion of the internal terminal is perpendicular to an extension direction of the external tabs of the one of the C cathode electrodes and the A anode electrodes through the slot; and
the slot is defined on the second portion of the internal terminal.

4. The battery cell of claim 1, wherein a taper of each of the first leg and the second leg extends from the closed end of the slot to the open end of the slot.

5. The battery cell of claim 1, wherein:
each of the first leg and the second leg includes a taper portion and a straight portion;
the second width of the slot is constant along the straight portion of the first leg and the second leg; and
the taper portion includes a chamfer at the open end of the slot.

6. The battery cell of claim 1, wherein:
each of the first leg and the second leg includes a taper portion and a straight portion;
the second width of the slot is constant along the straight portion of the first leg and the second leg; and
the taper portion includes a round curve at the open end of the slot.

7. The battery cell of claim 1, wherein a weld of the slot to the external tabs of the one of the C cathode electrodes and the A anode electrodes extending through the slot is a laser oscillation weld.

8. A battery cell, comprising:
a stack including:
C cathode electrodes each including a cathode current collector, a cathode active layer arranged on the cathode current collector, and an external tab extending from the cathode current collector;
A anode electrodes each including an anode current collector, an anode active layer arranged on the anode current collector, and an external tab extending from the anode current collector; and
S separators, where C, A and S are integers greater than one;
an internal terminal top plate;
an internal terminal first leg; and
an internal terminal second leg, wherein,
the external tabs of one of the C cathode electrodes and the A anode electrodes extend between the internal terminal first leg and the internal terminal second leg, and are welded to the internal terminal first leg and the internal terminal second leg,
the internal terminal first leg is welded to the internal terminal top plate, and
the internal terminal second leg is welded to the internal terminal top plate.

9. The battery cell of claim 8, wherein:
the internal terminal top plate is “L”-shaped and includes a first portion and a second portion extending transversely relative to the first portion; and
the internal terminal first leg and the internal terminal second leg are welded to opposite sides of the second portion of the internal terminal top plate.

10. The battery cell of claim 8, wherein
the internal terminal top plate includes a protrusion extending along a center of a surface of the internal terminal top plate; and
the internal terminal first leg and the internal terminal second leg are welded to opposite sides of the protrusion of the internal terminal top plate.

11. The battery cell of claim 8, wherein an angle between a plane of the internal terminal top plate and a longitudinal direction of the internal terminal first leg and the internal terminal second leg is ninety degrees.

12. The battery cell of claim 8, wherein each of the internal terminal top plate, the internal terminal first leg, and the internal terminal second leg, are rectangular.

13. The battery cell of claim 8, wherein:
each of the internal terminal first leg and the internal terminal second leg includes a curved portion and a straight portion; and
the curved portion of each of the internal terminal first leg and the internal terminal second leg is welded to the internal terminal top plate.

14. The battery cell of claim 13, wherein a first width between the straight portion of each of the internal terminal first leg and the internal terminal second leg is less than a width between the curved portion of each of the internal terminal first leg and the internal terminal second leg where each curved portion is welded to the internal terminal top plate.

15. The battery cell of claim 8, wherein:
the internal terminal second leg is “L”-shaped and includes a first portion and a second portion extending transversely relative to the first portion; and
the first portion of the internal terminal second leg is welded to the internal terminal top plate.

16. The battery cell of claim 8, wherein a thickness of each of the internal terminal first leg and the internal terminal second leg is less than a thickness of the internal terminal top plate.

17. The battery cell of claim 8, wherein a thickness of each of the internal terminal first leg and the internal terminal second leg is greater than or equal to a thickness of the internal terminal top plate.

18. A battery cell, comprising:
a stack including:
C cathode electrodes each including a cathode current collector, a cathode active layer arranged on the cathode current collector, and an external tab extending from the cathode current collector;
A anode electrodes each including an anode current collector, an anode active layer arranged on the anode current collector, and an external tab extending from the anode current collector; and
S separators, where C, A and S are integers greater than one;
an internal terminal; and
a side plate, wherein,
the internal terminal is “L”-shaped and includes a first portion and a second portion extending transversely relative to the first portion,
the external tabs of one of the C cathode electrodes and the A anode electrodes extend between the second portion of the internal terminal and the side plate, and are welded to the second portion of the internal terminal and the side plate, and
a plane of the second portion of the internal terminal and a plane of the side plate are parallel to an extension direction of the external tabs of the one of the C cathode electrodes and the A anode electrodes extending between the second portion of the internal terminal and the side plate.

19. The battery cell of claim 18, wherein the side plate is welded to only the second portion of the internal terminal and the external tabs of the one of the C cathode electrodes and the A anode electrodes extending between the second portion of the internal terminal and the side plate, without any welds between the side plate and the first portion of the internal terminal.

20. The battery cell of claim 18, wherein a thickness of the side plate is less than a thickness of the second portion of the internal terminal.
